(19) United States
(12) Patent Application Publication
(10) Pub. No.: US 2018/0234846 A1
(43) Pub. Date: Aug. 16, 2018

(54) PAIRING ELECTRONIC DEVICES

(71) Applicant: Intel Corporation, Santa Clara, CA (US)

(72) Inventors: Jiancheng TAO, Shanghai (CN); Hong W. WONG, Portland, OR (US); Jun LIU, Shanghai (CN); Xiaoguo LIANG, Shanghai (CN)

(73) Assignee: Intel Corporation, Santa Clara, CA (US)

(21) Appl. No.: 15/751,274

(22) PCT Filed: Sep. 28, 2015
(86) PCT No.: PCT/CN2015/090911

§ 371 Date: Feb. 8, 2018

(51) Int. Cl. H04W 12/06; G06F 21/44; G06F 21/45; H04L 9/08; H04L 9/32; H04W 4/80; H04W 76/14

(52) U.S. Cl. CPC H04W 12/06; G06F 21/44; G06F 21/45; H04W 76/14; H04L 9/3226; H04W 4/80; H04L 9/0861

(57) ABSTRACT

In one embodiment an electronic device includes a vibration generator and logic, at least partially including hardware logic, configured to obtain a pairing passcode, generate a vibration pattern from the pairing passcode, receive an acknowledgement from a remote electronic device and in response to the acknowledgment, authorize a pairing relationship with the remote electronic device. Other embodiments may be described.

### BACKGROUND

The subject matter described herein relates generally to the field of electronic devices and more particularly to a system and method to implement pairing of electronic devices.

The term “pairing” refers to techniques implemented in two or more electronic devices to enable the electronic devices to establish a communication connection. Existing pairing techniques commonly rely upon a user inputting one or more passwords into a user interface of the electronic device(s), which is time consuming and raises privacy issues. Accordingly additional systems and techniques to provide pairing between electronic devices may find utility.

### BRIEF DESCRIPTION OF THE DRAWINGS

The detailed description is described with reference to the accompanying figures.

FIGS. 1-2 are schematic illustrations of exemplary electronic devices which may be adapted to implement pairing in accordance with some embodiments.

FIG. 3 is a high-level schematic illustration of an exemplary architecture for pairing in accordance with some embodiments.

FIGS. 4-5 are flowcharts illustrating operations in methods to implement pairing in accordance with some embodiments.

FIGS. 6-10 are schematic illustrations of electronic devices which may be adapted to implement pairing in accordance with some embodiments.

### DETAILED DESCRIPTION

Described herein are exemplary systems and methods to implement pairing in electronic devices. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

Various embodiments described herein enable mobile electronic devices, e.g., smart phones, laptop computers, tablet computers, electronic readers, and the like to implement pairing operations, e.g., in order to establish a communication connection. By way of example, pairing operations may be based on vibration patterns generated from a passcode which in some examples may be random and in other examples may be generated by a remote electronic device such as a pairing passcode server. Electronic devices may include vibration generates such as vibrators to generate vibration patterns and sensors such as accelerometers or the like to detect the vibrations.

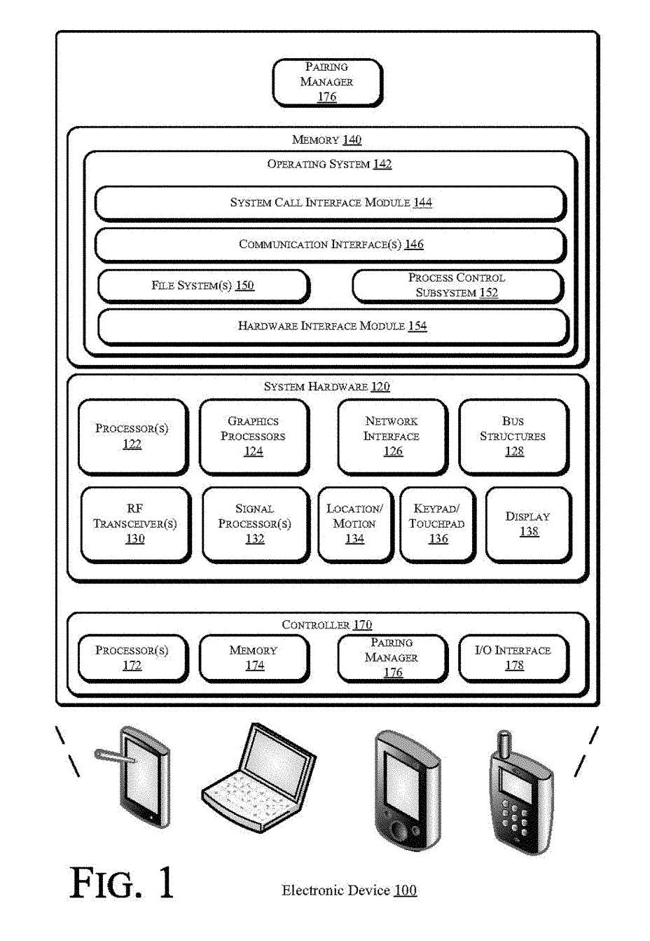

In some embodiments described herein a pairing manager may be implemented on an electronic device. The pairing manager may be embodied as logic, e.g., hardware, software, firmware, or combinations thereof which operate on the electronic device or on one or more components thereof. In an electronic device that initiates a pairing relationship, the logic may be configured to obtain a pairing passcode, generate a vibration pattern from the pairing passcode, receive an acknowledgement from a remote electronic device, and in response to the acknowledgment, authorize a pairing relationship with the remote electronic device. Further aspects will be described with reference to the figures. In an electronic device that receives an invitation to a pairing relationship, the logic may be configured to receive a vibration pattern from a remote electronic device and generate an acknowledgment vibration pattern when the vibration pattern received from the remote device matches the pairing passcode. Additional details and features will be described with reference to FIGS. 1-10, below.

FIG. 1 is a schematic illustration of an electronic device 100 which may be adapted to implement pairing in accordance with some examples. In various examples, electronic device 100 may include or be coupled to one or more accompanying input/output devices including a display, one or more speakers, a keyboard, one or more other I/O device(s), a mouse, a camera, or the like. Other exemplary I/O device(s) may include a touch screen, a voice-activated input device, a track ball, a geolocation device, an accelerometer/gyroscope, biometric feature input devices, and any other device that allows the electronic device 100 to receive input from a user.

The electronic device 100 includes system hardware 120 and memory 140, which may be implemented as random access memory and/or read-only memory. A file store may be communicatively coupled to electronic device 100. The file store may be internal to electronic device 100 such as, e.g., eMMC, SSD, one or more hard drives, or other types of storage devices. Alternatively, the file store may also be external to electronic device 100 such as, e.g., one or more external hard drives, network attached storage, or a separate storage network.

System hardware 120 may include one or more processors 122, graphics processors 124, network interfaces 126, and bus structures 128. In one embodiment, processor 122 may be embodied as an Intel® Atom™ processors, Intel® Atom™ based System-on-a-Chip (SOC) or Intel® Core2 Duo® or i3/i5/i7 series processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated onto the motherboard of electronic device 100 or may be coupled via an expansion slot on the motherboard or may be located on the same die or same package as the Processing Unit.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI), a High Speed Synchronous Serial Interface (HSI), a Serial Low-power Inter-chip Media Bus (SLIMbus®), or the like.

Electronic device 100 may include an RF transceiver 130 to transceive RF signals, a Near Field Communication (NFC) radio 134, and a signal processing module 132 to process signals received by RF transceiver 130. RF transceiver may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a WCDMA, LTE, general packet radio service (GPRS) interface (see, e.g., Guidelines on GPRS Handset Requirements, Global System for Mobile Communications/GSM Association, Ver. 3.0.1, December 2002).

Electronic device 100 may further include one or more location/motion devices 134 and input/output interfaces such as, e.g., a keypad 136 and a display 138. In some examples electronic device 100 may not have a keypad and may use the touch panel for input.

Memory 140 may include an operating system 142 for managing operations of electronic device 100. In one embodiment, operating system 142 includes a hardware interface module 154 that provides an interface to system hardware 120. In addition, operating system 140 may include a file system 150 that manages files used in the operation of electronic device 100 and a process control subsystem 152 that manages processes executing on electronic device 100.

Operating system 142 may include (or manage) one or more communication interfaces 146 that may operate in conjunction with system hardware 120 to transceive data packets and/or data streams from a remote source. Operating system 142 may further include a system call interface module 144 that provides an interface between the operating system 142 and one or more application modules resident in memory 130. Operating system 142 may be embodied as a UNIX operating system or any derivative thereof (e.g., Linux, Android, etc.) or as a Windows® brand operating system, or other operating systems.

In some examples an electronic device may include a controller 170, which may comprise one or more controllers that are separate from the primary execution environment. The separation may be physical in the sense that the controller may be implemented in controllers which are physically separate from the main processors. Alternatively, the trusted execution environment may be logical in the sense that the controller may be hosted on same chip or chipset that hosts the main processors.

By way of example, in some examples the controller 170 may be implemented as an independent integrated circuit located on the motherboard of the electronic device 100, e.g., as a dedicated processor block on the same SOC die. In other examples the trusted execution engine may be implemented on a portion of the processor(s) 122 that is segregated from the rest of the processor(s) using hardware enforced mechanisms.

In the embodiment depicted in FIG. 1 the controller 170 comprises a processor 172, a memory module 174, a pairing manager 176, and an I/O interface 178. In some examples the memory module 174 may comprise a persistent flash memory module and the various functional modules may be implemented as logic instructions encoded in the persistent memory module, e.g., firmware or software. The I/O module 178 may comprise a serial I/O module or a parallel I/O module. Because the controller 170 is separate from the main processor(s) 122 and operating system 142, the controller 170 may be made secure, i.e., inaccessible to hackers who typically mount software attacks from the host processor 122. In some examples portions of the pairing manager 176 may reside in the memory 140 of electronic device 100 and may be executable on one or more of the processors 122.

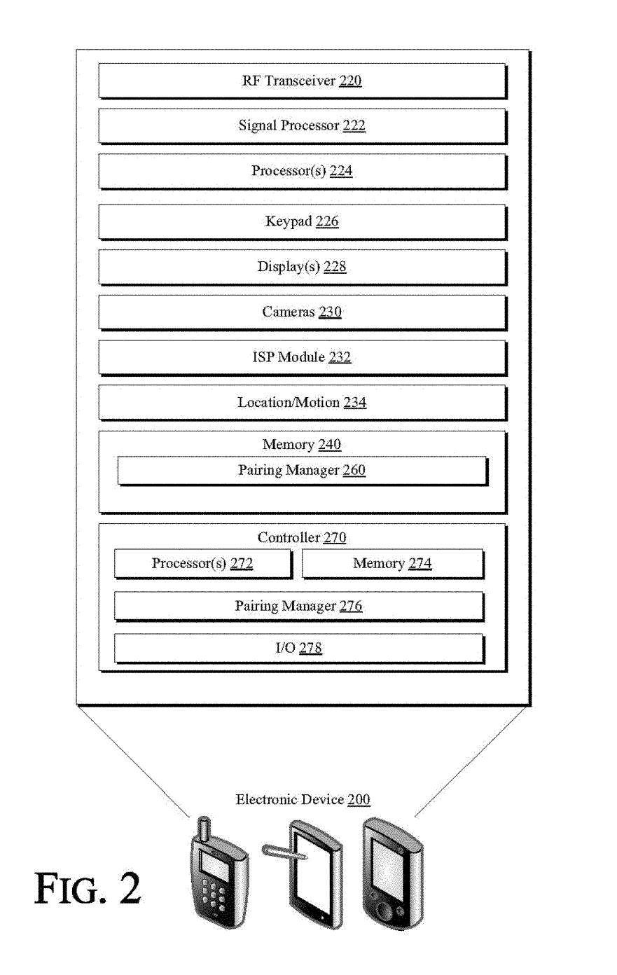

FIG. 2 is a schematic illustration of another embodiment of an electronic device 200 which may be adapted to implement pairing, according to embodiments. In some embodiments electronic device 210 may be embodied as a mobile telephone, a personal digital assistant (PDA), a laptop computer, or the like. Electronic device 200 may include an RF transceiver 220 to transceive RF signals and a signal processing module 222 to process signals received by RF transceiver 220.

RF transceiver 220 may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Electronic device 200 may further include one or more processors 224 and a memory module 240. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. In some embodiments, processor 224 may be one or more processors in the family of Intel® PXA27x processors available from Intel® Corporation of Santa Clara, Calif. Alternatively, other CPUs may be used, such as Intel's Itanium®, XEON™ ATOM™, and Celeron® processors. Also, one or more processors from other manufactures may be utilized. Moreover, the processors may have a single or multi core design.

In some embodiments, memory module 240 includes random access memory (RAM); however, memory module 240 may be implemented using other memory types such as dynamic RAM (DRAM), synchronous DRAM (SDRAM), and the like. Memory 240 may comprise one or more applications which execute on the processor(s) 222. In the embodiment depicted in FIG. 2 the applications comprise a pairing manager 260.

Electronic device 210 may further include one or more input/output interfaces such as, e.g., a keypad 226 and one or more displays 228. In some embodiments electronic device 210 comprises one or more camera modules 230 and an image signal processor 232 and one or more location/motion devices 234.

In some embodiments electronic device 210 may include a controller 270 which may be implemented in a manner analogous to that of controller 170, described above. In the embodiment depicted in FIG. 2 the adjunct controller 270 comprises one or more processor(s) 272, a memory module 274, a pairing manager 276 and an I/O module 278. In some embodiments the memory module 274 may comprise a persistent flash memory module and the pairing manager 276 may be implemented as logic instructions encoded in the persistent memory module, e.g., firmware or software. The I/O module 278 may comprise a serial I/O module or a parallel I/O module. Again, because the adjunct controller 270 is physically separate from the main processor(s) 224, the adjunct controller 270 may be made secure, i.e., inaccessible to hackers such that it cannot be tampered with. In some embodiments the pairing manager 260 may be implemented in the controller 270 such that the pairing manager 260 operates in a low power consumption environment.

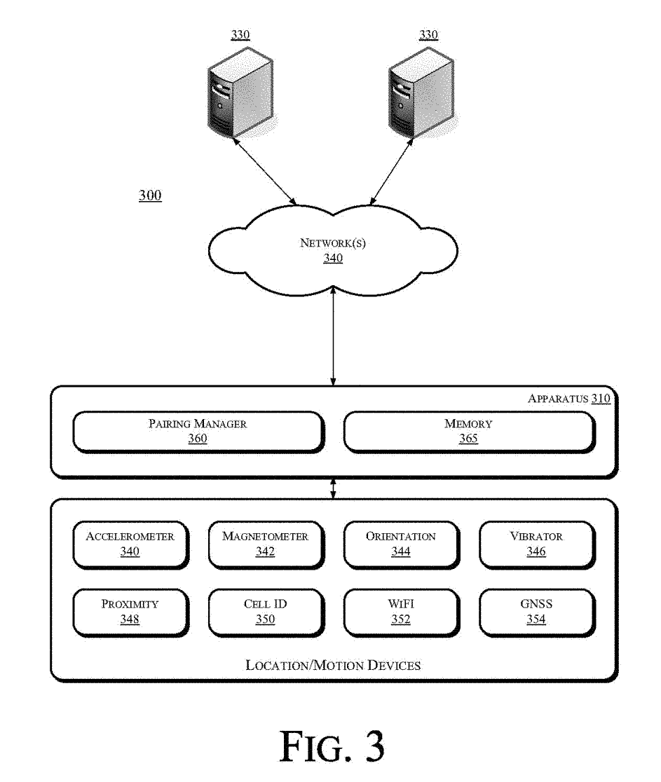

FIG. 3 is a high-level schematic illustration of an exemplary architecture 300 for pairing electronic devices such as electronic device 100 and electronic device 200 in accordance with some embodiments. Referring to FIG. 3, in some examples the apparatus 310 may be embodied as a processing device, e.g., a controller, which comprises a pairing manager 360 and a local memory 365. In some examples apparatus 310 be coupled to one or more location/motion devices to provide location and/or motion inputs to the pairing manager 360. In some embodiments the location/motion devices may comprise one or more of an accelerometer 340, a magnetometer 342, a orientation sensor 344, a vibrator 346, a proximity detector 348, cellular network identifier 350, a WiFi identifier 352, or a global navigation satellite system (GNSS) receiver 354. Apparatus 310 may be communicatively coupled to one or more passcode servers 330 via one or more communication networks 340.

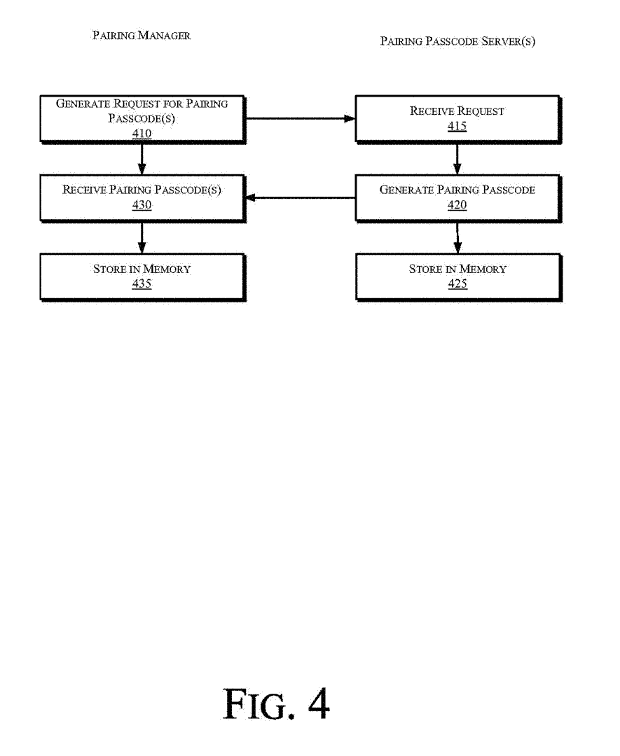

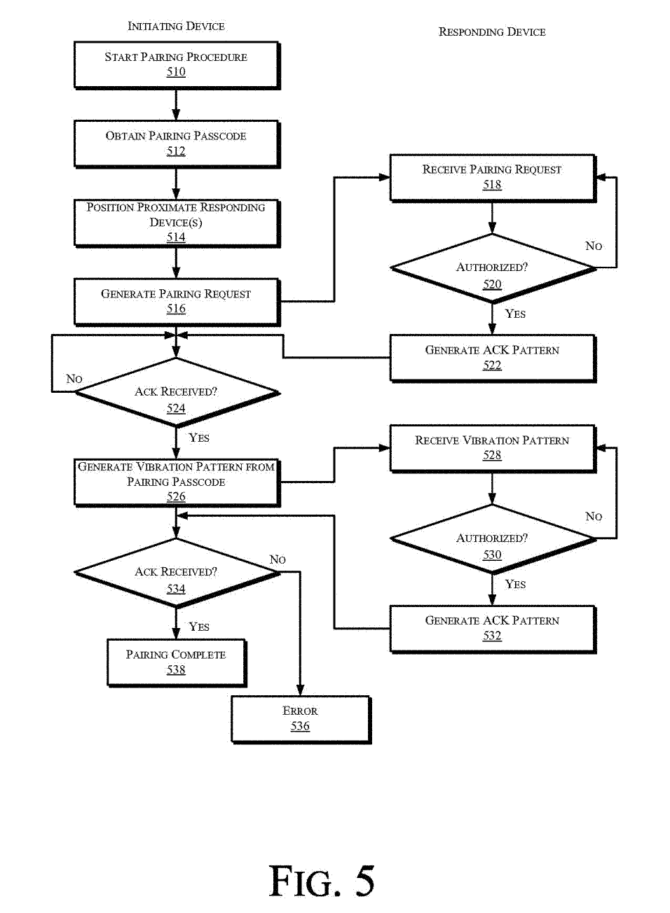

As described above, in some embodiments the pairing manager 360 implements a pairing logic which manages a pairing process between electronic devices such as electronic device 100 and electronic device 200. Having described various structures of a system to implement pairing, operating aspects of a system will be explained with reference to FIGS. 4-5, which are flowcharts illustrating operations in a method to implement pairing in accordance with some embodiments. The operations depicted in the flowchart of FIG. 4 may be implemented by the pairing manager 360 of the apparatus 310.

In some examples the pairing manager 360 implements operations to obtain a passcode from one or more remote passcode servers 330. Referring to FIG. 4, at operation 410 the pairing manager 360 generates a request for one pairing passcodes. In some examples the request may be generated an operation in a configuration process which configures an electronic device such as electronic devices 100 or 200 to establish a pairing relationship with another electronic device. In other examples the request may be generated during a pairing process. The request for a pairing passcode may be transmitted to one or more passcode servers 330 via the communication network(s) 340. The request for the passcode may include one or more identifiers which uniquely identify the pairing manager 360, an electronic device such as electronic device 100 or 200 which incorporates the paring manager, a user of the electronic device, an application executing on the electronic device, or combinations thereof. Alternatively, or in addition, the request may include a time stamp associated with the request and/or location information which may be derived from one or more of the location devices such as a cell identifier 350, a WiFi identifier 352, or a GNSS identifier from GNSS module 354.

At operation 415 the pairing passcode server(s) 330 receive the request from the pairing manager 360, and at operation 420 the pairing passcode server(s) generate pairing passcode. In some examples the pairing passcode may be as an alphanumeric code or as a strictly numeric code, e.g., a binary code. The pairing passcode may be associated uniquely with the specific request generated at operation 410. Alternatively, or in addition, the pairing passcode may be associated with an electronic device such as electronic device 100 or 200 which incorporates the paring manager, a user of the electronic device, an application executing on the electronic device, or combinations thereof. Alternatively, or in addition, the request may be associated with the time stamp associated with the request and/or location information which may be derived from one or more of the location devices such as a cell identifier 350, a WiFi identifier 352, or a GNSS identifier from GNSS module 354.

At operation 425 the passcode generated in operation 420 may be stored in a memory in, or communicatively coupled to, the pairing passcode server(s) 330. Any other data associated with the passcode may be stored in memory with the passcode.

At operation 430 the pairing manager 360 that initiated the request for a pairing passcode(s) in operation 410 receives the passcode(s) from the pairing passcode server(s) 330. The pairing passcode server(s) 330 may include additional information with the passcode(s), e.g., a timestamp associated with the passcode(s), a network address(es) associated with the pairing passcode server(s) 330 which generated the passcode, or the like.

At operation 435 the pairing manger 360 stores the pairing passcode(s) received from the passcode server(s) 330 in a memory. In some examples the memory may be a local memory such as memory 365. In other examples the memory may be a memory in, or communicatively coupled to, an electronic device such as electronic device 100 or 200, which incorporates the apparatus 310.

FIG. 5 is a flowchart illustrating operations in method for pairing electronic devices. The operations depicted in FIG. 5 represent a pairing method between a first device and a second device. In some examples the first device may be one of electronic devices 100 or 200 and the second device may be the other of electronic devices 100 or 200. In FIG. 5 the device which initiates the pairing request is referred to as the “initiating device” while the other device is referred to as the “responding” device.

In the method illustrated Referring to FIG. 5, at operation 510 the initiating device starts a pairing procedure. In some examples the pairing procedure may be started by a user interacting with the initiating device via a user interface, e.g., by invoking a pairing application. In other examples a pairing application may be started in response to environmental conditions. For example, a near field controller (NFC) or other wireless communication device on the initiating device may detect the presence of the receiving device and, in response to detecting the presence of the receiving device, may start a pairing procedure.

At operation 512 the initiating device obtains a pairing passcode. In some examples the initiating device may obtain the pairing passcode by invoking the operations depicted in FIG. 4. In other examples the passcode may be generated by the initiating device. For example, the passcode may be generated by pairing manager 360 as a random or pseudo-random number, or as a number in a predetermined sequence.

At operation 514 the initiating device is positioned proximate the responding device. In some examples the initiating device may be placed in direct physical contact with the receiving device, while in other examples the initiating device may be positioned sufficiently close to the receiving device to allow the receiving device to detect vibrations generated by the initiating device.

At operation 516 the initiating device generates a pairing request. In some examples the pairing request may include a vibration pattern generated by the vibrator 346 in the initiating device. For example, pairing manager 360 may provide a signal to the vibrator 346 of the initiating device. In response to the signal, the vibrator 346 may generate a vibration pattern. They vibration pattern output by the vibrator 346 may cause the initiating device to vibrate with a series of frequencies over time. The pairing request may also include any or all of the information associated with the passcode that was stored in memory in operation 435. In some examples the information associated with the passcode may be encoded into a vibration pattern with the passcode. In other examples the information associated with the passcode may be transmitted via a separate communication link, e.g., a wireless or wired communication link.

At operation 518 the responding device receives the pairing request from the initiating device. For example, the accelerometer 340 in the responding device may detect the vibration pattern generated by the vibrator 346 in the initiating device. The pairing manager 360 may receive an output of the vibrator 346 and decode the output to reconstruct a signal from the vibration pattern. In addition, any information associated with the passcode may be decoded as necessary by the receiving device.

At operation 520 the responding device determines whether the initiating device is authorized to initiate a pairing with the receiving device. In some examples the receiving device may accept a pairing request from any initiating device, in which case any pairing request will be authorized. In other examples the pairing request may have to originate from an authorized initiating device. For example, the pairing request may include an identifier uniquely associated with the initiating device. The identifier may have been assigned by the pairing passcode server(s) in operation 420 and stored in a memory of the initiating device in operation 435. In response to the pairing request the responding device may determine whether the initiating device is authorized by launching a query to the pairing passcode server(s) 330. The query may include the identifier uniquely associated with the initiating device. In response to the query from the responding device, the pairing passcode server 330 may provide an indication that the initiating device is authorized if the identifier uniquely associated with the initiating device is registered with the pairing passcode server 330, either in a configuration process as depicted in FIG. 4 or during a separate registration process.

If, at operation 520 the initiating device is not authorized to initiate a pairing procedure with the responding device then control passes back to operation 518 and the pairing manager 360 in the responding device waits to receive another pairing request.

By contrast, if at operation 520 the initiating device is authorized to initiate a pairing procedure with the responding device then control passes to operation 522 and the pairing manager 360 in the responding device generates an acknowledgment pattern. In some examples the acknowledgment pattern may be implemented as a vibration pattern generated by a vibrator 346 in the responding device.

If, at operation 524 the initiating device fails to detect an acknowledgment from the responding device indicating that the initiating device is authorized to initiate a pairing procedure with the responding device then the initiating device waits to receive an acknowledgment.

By contrast, if at operation 524 the initiating device receives an acknowledgment from the responding device then control passes to operation 526 and the pairing manager 360 in the initiating device generates an vibration pattern from the pairing passcode(s) obtained in operation 512. For example, pairing manager 360 may provide the passcode, or a derivative thereof, to the vibrator 346 of the initiating device. In response to the passcode input, the vibrator 346 may generate a vibration pattern that corresponds to the passcode. They vibration pattern output by the vibrator 346 may cause the initiating device to vibrate with a series of frequencies over time that correspond to the passcode. The pairing request may also include any or all of the information associated with the passcode that was stored in memory in operation 435. In some examples the information associated with the passcode may be encoded into a vibration pattern with the passcode. In other examples the information associated with the passcode may be transmitted via a separate communication link, e.g., a wireless or wired communication link.

At operation 528 the responding device receives the vibration pattern from the initiating device. For example, the accelerometer 340 in the responding device may detect the vibration pattern generated by the vibrator 346 in the initiating device. The pairing manager 360 may receive an output of the vibrator 346 and decode the output to reconstruct a passcode from the vibration pattern. In addition, any information associated with the passcode may be decoded as necessary by the receiving device.

At operation 530 the responding device determines whether the initiating device is authorized to establish a pairing relationship with the receiving device. In some examples the receiving device may establish a pairing relationship with any initiating device, in which case any passcode will be accepted by default. In other examples the pairing request may have to match a passcode from an authorized initiating device. For example, the responding device may determine whether the passcode corresponding to the vibration pattern generated by the initiating device matches a passcode from an authorized device by launching a query to the pairing passcode server(s) 330. The query may include the identifier uniquely associated with the initiating device. In response to the query from the responding device, the pairing passcode server 330 may provide the passcode associated with the initiating device to the pairing manager 360 in the responding device

If, at operation 530 the passcode received from the pairing passcode server 330 does not match the passcode received from the initiating device then the pairing manager 360 in the responding device determines that the initiating device is not authorized to establish a pairing relationship with the responding device then control passes back to operation 528 and the pairing manager 360 in the responding device waits to receive another vibration pattern.

By contrast, if at operation 530 the passcode received from the pairing passcode server 330 does matches the passcode received from the initiating device then the pairing manager 360 in the responding device determines that the initiating device is authorized to establish a pairing relationship with the responding device then control passes to operation 532 and the pairing manager 360 in the responding device generates an acknowledgment pattern. In some examples the acknowledgment pattern may be implemented as a vibration pattern generated by a vibrator 346 in the responding device.

If, at operation 524 the initiating device fails to detect an acknowledgment from the responding device indicating that the initiating device is authorized to establish a pairing procedure with the responding device then control passes to operation 536 and the initiating device waits to receive an acknowledgment.

By contrast, if at operation 524 the initiating device receives an acknowledgment from the responding device then control passes to operation 538 and the respective pairing managers 360 in the initiating device and receiving device establish a pairing relationship.

The pairing relationship may be terminated in a number of different ways. In some examples either the initiating device or the responding device may transmit a request to terminate the pairing relationship. Alternatively, or in addition, a user may terminate the connection by pressing a reset or power down button on a user interface to terminate any pairing relationships with the device. Alternatively, or in addition, a pairing relationship may have a defined lifespan and may terminate upon expiration of the defined lifespan.

Thus, the systems and methods described herein enable an electronic device such as electronic device 100 or 200 to establish a pairing relationship using a vibration generator such as a vibrator 346. This eliminates the need for a user to enter passcode(s) via a user interface and provides a secure way to transmit the passcode(s) from an initiating device to a responding device.

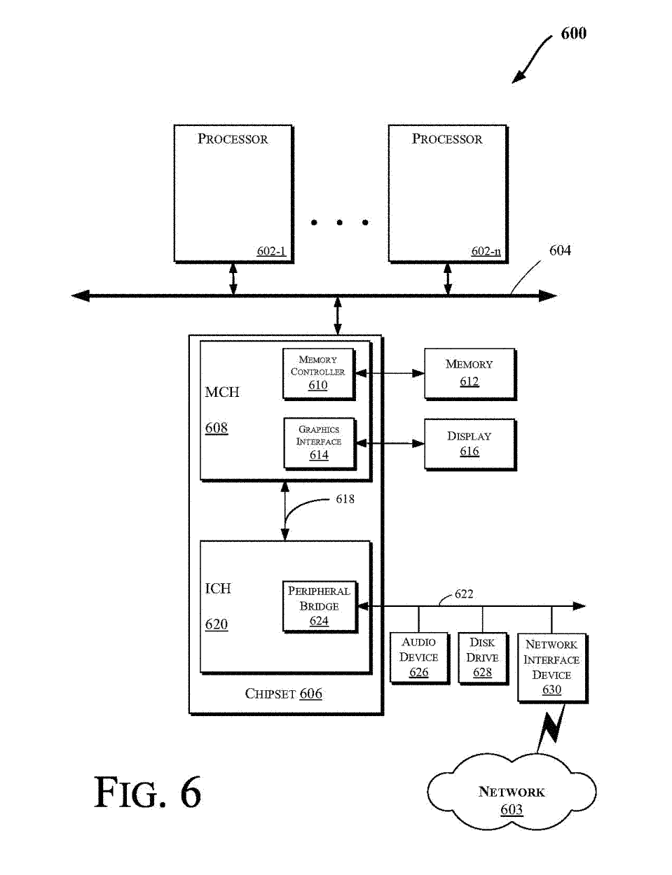

As described above, in some embodiments the electronic device may be embodied as a computer system. FIG. 6 illustrates a block diagram of a computing system 600 in accordance with an embodiment of the invention. The computing system 600 may include one or more central processing unit(s) (CPUs) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an embodiment, one or more of the processors 602 may be the same or similar to the processors 102 of FIG. 1. For example, one or more of the processors 602 may include the control unit 120 discussed with reference to FIGS. 1-3. Also, the operations discussed with reference to FIGS. 3-5 may be performed by one or more components of the system 600.

A chipset 606 may also communicate with the interconnection network 604. The chipset 606 may include a memory control hub (MCH) 608. The MCH 608 may include a memory controller 610 that communicates with a memory 612 (which may be the same or similar to the memory 130 of FIG. 1). The memory 412 may store data, including sequences of instructions, that may be executed by the CPU 602, or any other device included in the computing system 600. In one embodiment of the invention, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple CPUs and/or multiple system memories.

The MCH 608 may also include a graphics interface 614 that communicates with a display device 616. In one embodiment of the invention, the graphics interface 614 may communicate with the display device 616 via an accelerated graphics port (AGP). In an embodiment of the invention, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the CPU 602 and peripheral devices. Other types of topologies may be utilized. Also, multiple buses may communicate with the ICH 620, e.g., through multiple bridges or controllers. Moreover, other peripherals in communication with the ICH 620 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some embodiments of the invention. In addition, the processor 602 and one or more other components discussed herein may be combined to form a single chip (e.g., to provide a System on Chip (SOC)). Furthermore, the graphics accelerator 616 may be included within the MCH 608 in other embodiments of the invention.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

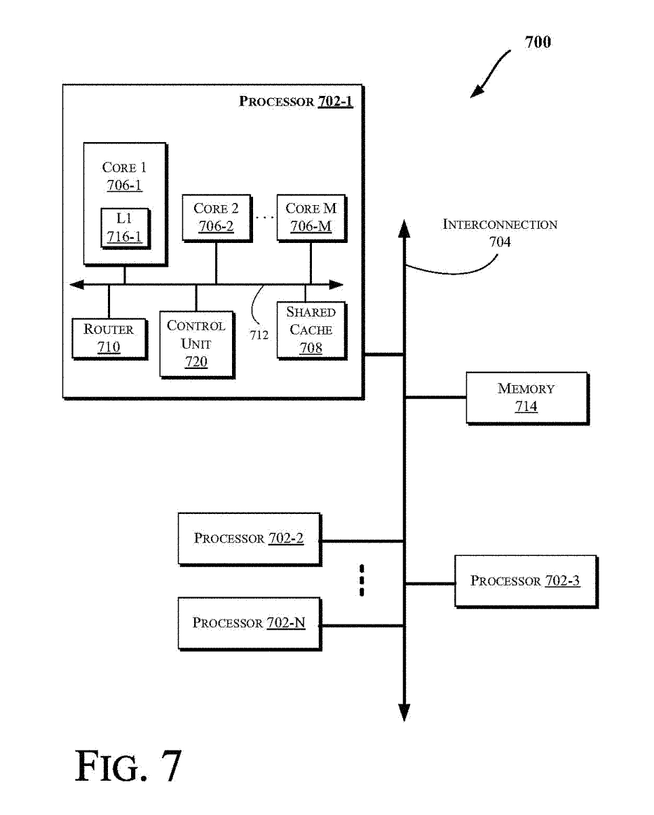

FIG. 7 illustrates a block diagram of a computing system 700, according to an embodiment of the invention. The system 700 may include one or more processors 702-1 through 702-N (generally referred to herein as “processors 702” or “processor 702”). The processors 702 may communicate via an interconnection network or bus 704. Each processor may include various components some of which are only discussed with reference to processor 702-1 for clarity. Accordingly, each of the remaining processors 702-2 through 702-N may include the same or similar components discussed with reference to the processor 702-1.

In an embodiment, the processor 702-1 may include one or more processor cores 706-1 through 706-M (referred to herein as “cores 706” or more generally as “core 706”), a shared cache 708, a router 710, and/or a processor control logic or unit 720. The processor cores 706 may be implemented on a single integrated circuit (IC) chip. Moreover, the chip may include one or more shared and/or private caches (such as cache 708), buses or interconnections (such as a bus or interconnection network 712), memory controllers, or other components.

In one embodiment, the router 710 may be used to communicate between various components of the processor 702-1 and/or system 700. Moreover, the processor 702-1 may include more than one router 710. Furthermore, the multitude of routers 710 may be in communication to enable data routing between various components inside or outside of the processor 702-1.

The shared cache 708 may store data (e.g., including instructions) that are utilized by one or more components of the processor 702-1, such as the cores 706. For example, the shared cache 708 may locally cache data stored in a memory 714 for faster access by components of the processor 702. In an embodiment, the cache 708 may include a mid-level cache (such as a level 2 (L2), a level 3 (L3), a level 4 (L4), or other levels of cache), a last level cache (LLC), and/or combinations thereof. Moreover, various components of the processor 702-1 may communicate with the shared cache 708 directly, through a bus (e.g., the bus 712), and/or a memory controller or hub. As shown in FIG. 7, in some embodiments, one or more of the cores 706 may include a level 1 (L1) cache 716-1 (generally referred to herein as “L1 cache 716”).

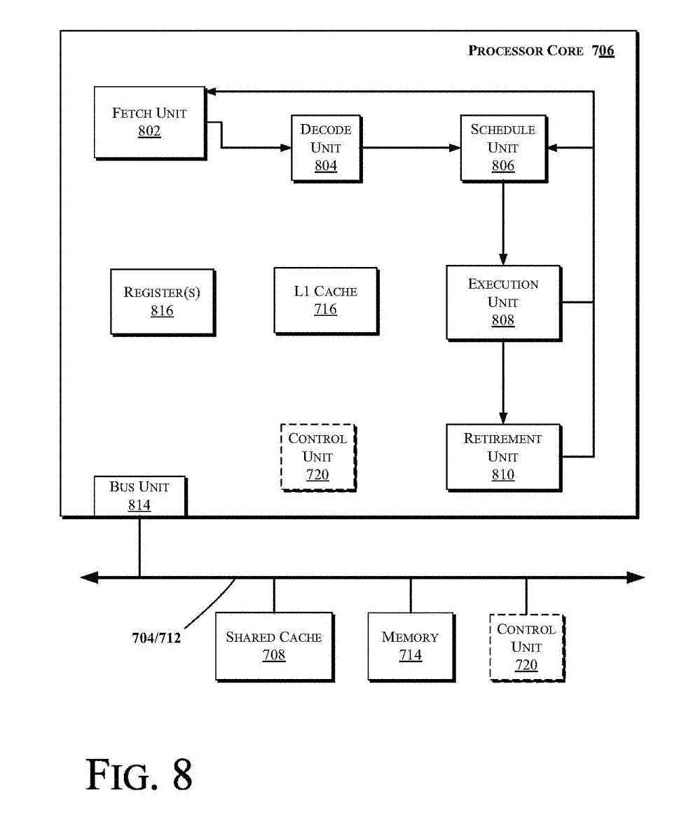

FIG. 8 illustrates a block diagram of portions of a processor core 706 and other components of a computing system, according to an embodiment of the invention. In one embodiment, the arrows shown in FIG. 8 illustrate the flow direction of instructions through the core 706. One or more processor cores (such as the processor core 706) may be implemented on a single integrated circuit chip (or die) such as discussed with reference to FIG. 7. Moreover, the chip may include one or more shared and/or private caches (e.g., cache 708 of FIG. 7), interconnections (e.g., interconnections 704 and/or 112 of FIG. 7), control units, memory controllers, or other components.

As illustrated in FIG. 8, the processor core 706 may include a fetch unit 802 to fetch instructions (including instructions with conditional branches) for execution by the core 706. The instructions may be fetched from any storage devices such as the memory 714. The core 706 may also include a decode unit 804 to decode the fetched instruction. For instance, the decode unit 804 may decode the fetched instruction into a plurality of uops (micro-operations).

Additionally, the core 706 may include a schedule unit 806. The schedule unit 806 may perform various operations associated with storing decoded instructions (e.g., received from the decode unit 804) until the instructions are ready for dispatch, e.g., until all source values of a decoded instruction become available. In one embodiment, the schedule unit 806 may schedule and/or issue (or dispatch) decoded instructions to an execution unit 808 for execution. The execution unit 808 may execute the dispatched instructions after they are decoded (e.g., by the decode unit 804) and dispatched (e.g., by the schedule unit 806). In an embodiment, the execution unit 808 may include more than one execution unit. The execution unit 808 may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit 808.

Further, the execution unit 808 may execute instructions out-of-order. Hence, the processor core 706 may be an out-of-order processor core in one embodiment. The core 706 may also include a retirement unit 810. The retirement unit 810 may retire executed instructions after they are committed. In an embodiment, retirement of the executed instructions may result in processor state being committed from the execution of the instructions, physical registers used by the instructions being de-allocated, etc.

The core 706 may also include a bus unit 714 to enable communication between components of the processor core 706 and other components (such as the components discussed with reference to FIG. 8) via one or more buses (e.g., buses 804 and/or 812). The core 706 may also include one or more registers 816 to store data accessed by various components of the core 706 (such as values related to power consumption state settings).

Furthermore, even though FIG. 7 illustrates the control unit 720 to be coupled to the core 706 via interconnect 812, in various embodiments the control unit 720 may be located elsewhere such as inside the core 706, coupled to the core via bus 704, etc.

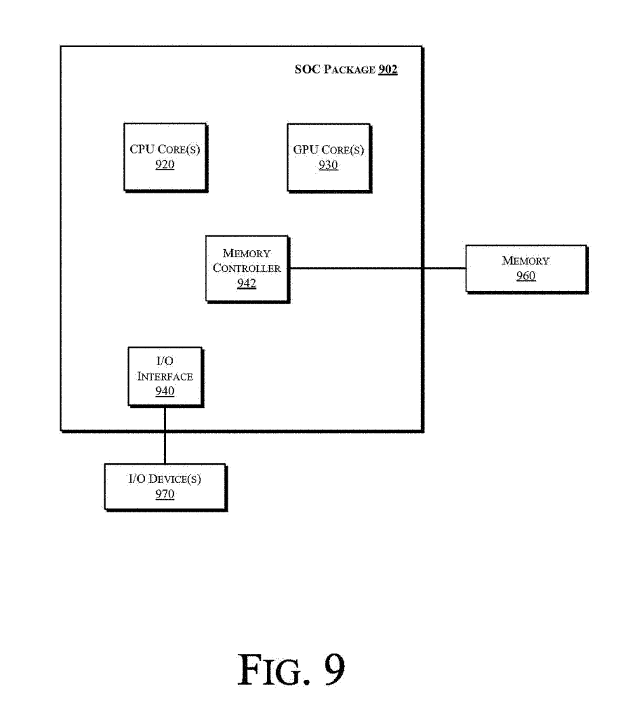

In some embodiments, one or more of the components discussed herein can be embodied as a System On Chip (SOC) device. FIG. 9 illustrates a block diagram of an SOC package in accordance with an embodiment. As illustrated in FIG. 9, SOC 902 includes one or more Central Processing Unit (CPU) cores 920, one or more Graphics Processor Unit (GPU) cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components, e.g., as discussed with reference to the other figures herein. In one embodiment, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an embodiment, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch screen, a speaker, or the like.

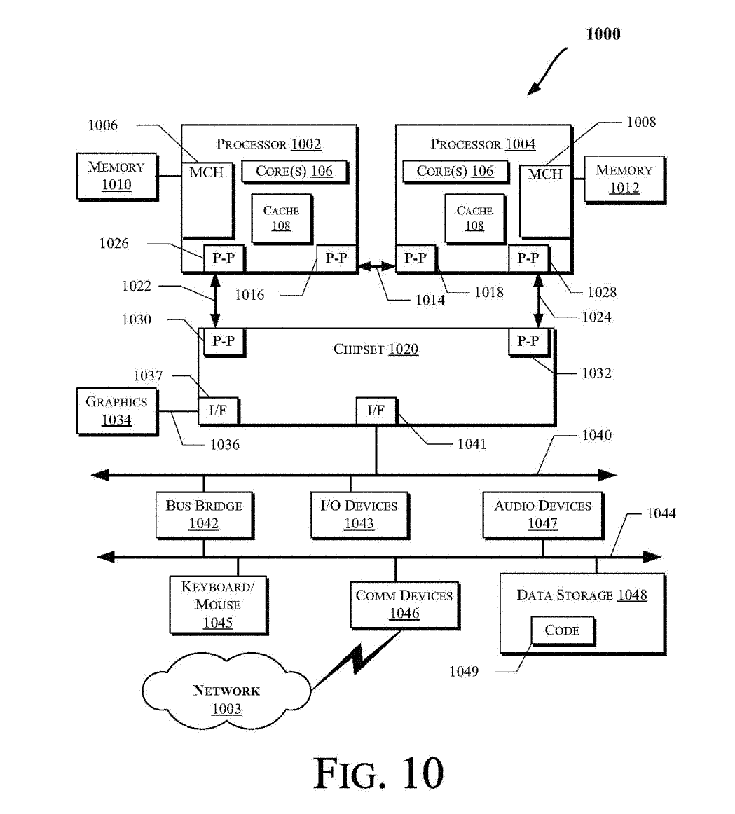

FIG. 10 illustrates a computing system 1000 that is arranged in a point-to-point (PtP) configuration, according to an embodiment of the invention. In particular, FIG. 10 shows a system where processors, memory, and input/output devices are interconnected by a number of point-to-point interfaces. As illustrated in FIG. 10, the system 1000 may include several processors, of which only two, processors 1002 and 1004 are shown for clarity. The processors 1002 and 1004 may each include a local memory controller hub (MCH) 1006 and 1008 to enable communication with memories 1010 and 1012.

In an embodiment, the processors 1002 and 1004 may be one of the processors 702 discussed with reference to FIG. 7. The processors 1002 and 1004 may exchange data via a point-to-point (PtP) interface 1014 using PtP interface circuits 1016 and 1018, respectively. Also, the processors 1002 and 1004 may each exchange data with a chipset 1020 via individual PtP interfaces 1022 and 1024 using point-to-point interface circuits 1026, 1028, 1030, and 1032. The chipset 1020 may further exchange data with a high-performance graphics circuit 1034 via a high-performance graphics interface 1036, e.g., using a PtP interface circuit 1037.

As shown in FIG. 10, one or more of the cores 106 and/or cache 108 of FIG. 1 may be located within the processors 1004. Other embodiments of the invention, however, may exist in other circuits, logic units, or devices within the system 1000 of FIG. 10. Furthermore, other embodiments of the invention may be distributed throughout several circuits, logic units, or devices illustrated in FIG. 10.

The chipset 1020 may communicate with a bus 1040 using a PtP interface circuit 1041. The bus 1040 may have one or more devices that communicate with it, such as a bus bridge 1042 and I/O devices 1043. Via a bus 1044, the bus bridge 1043 may communicate with other devices such as a keyboard/mouse 1045, communication devices 1046 (such as modems, network interface devices, or other communication devices that may communicate with the computer network 1003), audio I/O device, and/or a data storage device 1048. The data storage device 1048 (which may be a hard disk drive or a NAND flash based solid state drive) may store code 1049 that may be executed by the processors 1004.

The following examples pertain to further embodiments.

Example 1 is an electronic device comprising a vibration generator and logic, at least partially including hardware logic, configured to obtain a pairing passcode, generate a vibration pattern from the pairing passcode, receive an acknowledgement from a remote electronic device, and in response to the acknowledgment, authorize a pairing relationship with the remote electronic device.

In Example 2, the subject matter of Example 1 can optionally include logic further configured to initiate a request to a pairing passcode server, and in response to the request, receive a pairing passcode from the pairing passcode server.

In Example 3, the subject matter of any one of Examples 1-2 can optionally include an arrangement in which the pairing passcode comprises at least one of a user-specific component, an application-specific component, a geography-specific component, a time-specific component, or a random component.

In Example 4, the subject matter of any one of Examples 1-3 can optionally include memory to store the pairing passcode.

Example 5 is an apparatus comprising logic, at least partially including hardware logic, configured to obtain a pairing passcode, generate a vibration pattern in a vibration generator communicatively coupled to the apparatus from the pairing passcode, receive an acknowledgement from a remote electronic device, and in response to the acknowledgment, authorize a pairing relationship with the remote electronic device.

In Example 6, the subject matter of Example 5 can optionally include logic further configured to initiate a request to a pairing passcode server, and in response to the request, receive a pairing passcode from the pairing passcode server.

In Example 7, the subject matter of any one of Examples 5-6 can optionally include an arrangement in which the pairing passcode comprises at least one of a user-specific component, an application-specific component, a geography-specific component, a time-specific component, or a random component.

In Example 8, the subject matter of any one of Examples 5-7 can optionally include memory to store the pairing passcode.

Example 9 is a computer program product comprising logic instructions stored on a non-transitory computer readable medium which, when executed on a processor, configure the processor to obtain a pairing passcode, generate a vibration pattern in a vibration generator communicatively coupled to the apparatus from the pairing passcode, receive an acknowledgement from a remote electronic device and in response to the acknowledgment, authorize a pairing relationship with the remote electronic device.

In Example 10, the subject matter of Example 9 can optionally include logic instructions stored on a non-transitory computer readable medium which, when executed on a processor, configure the processor to initiate a request to a pairing passcode server, and in response to the request, receive a pairing passcode from the pairing passcode server.

In Example 11, the subject matter of any one of Examples 9-10 can optionally include an arrangement in which the pairing passcode comprises at least one of a user-specific component, an application-specific component, a geography-specific component, a time-specific component, or a random component.

In Example 12, the subject matter of any one of Examples 9-11 can optionally include memory to store the pairing passcode.

Example 13 is an electronic device comprising a vibration generator and logic, at least partially including hardware logic, configured to an accelerometer; and logic, at least partially including hardware logic, configured to receive a vibration pattern from a remote electronic device and generate an acknowledgment vibration pattern when the vibration pattern received from the remote device matches the pairing passcode.

In Example 14, the subject matter of Example 13 can optionally include logic configured to obtain a pairing passcode.

In Example 15, the subject matter of Example 13-14 can optionally include logic configured to initiate a request to a pairing passcode server and in response to the request, receive a pairing passcode from the pairing passcode server

In Example 16, the subject matter of any one of Examples 13-15 can optionally include an arrangement in which the pairing passcode comprises at least one of a user-specific component, an application-specific component, a geography-specific component, a time-specific component, or a random component.

In Example 17, the subject matter of any one of Examples 13-16 can optionally include memory to store the pairing passcode.

Example 18 is an apparatus, comprising logic, at least partially including hardware logic, configured to receive a vibration pattern from a remote electronic device, and generate an acknowledgment vibration pattern when the vibration pattern received from the remote device matches the pairing passcode.

In Example 19, the subject matter of Example 18 can optionally include logic configured to obtain a pairing passcode.

In Example 20, the subject matter of Example 18-19 can optionally include logic configured to initiate a request to a pairing passcode server and in response to the request, receive a pairing passcode from the pairing passcode server

In Example 21, the subject matter of any one of Examples 18-20 can optionally include an arrangement in which the pairing passcode comprises at least one of a user-specific component, an application-specific component, a geography-specific component, a time-specific component, or a random component.

In Example 22, the subject matter of any one of Examples 18-21 can optionally include memory to store the pairing passcode.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1-22. (canceled)

23. An electronic device, comprising:
a vibration generator; and
logic, at least partially including hardware logic, configured to:
obtain a pairing passcode;
generate a vibration pattern from the pairing passcode;
receive an acknowledgement from a remote electronic device; and
in response to the acknowledgment, authorize a pairing relationship with the remote electronic device.

24. The electronic device of claim 23, wherein the logic is further configured to:
initiate a request to a pairing passcode server; and
in response to the request, receive a pairing passcode from the pairing passcode server.

25. The electronic device of claim 24, wherein the pairing passcode comprises at least one of:
a user-specific component;
an application-specific component;
a geography-specific component;
a time-specific component; or
a random component.

26. The electronic device of claim 23, further comprising memory to store the pairing passcode.

27. An apparatus, comprising:
logic, at least partially including hardware logic, configured to:
obtain a pairing passcode;
generate a vibration pattern in a vibration generator communicatively coupled to the apparatus from the pairing passcode;
receive an acknowledgement from a remote electronic device; and
in response to the acknowledgment, authorize a pairing relationship with the remote electronic device.

28. The apparatus of claim 27, wherein the logic is further configured to:
initiate a request to a pairing passcode server; and
in response to the request, receive a pairing passcode from the pairing passcode server.

29. The apparatus of claim 28, wherein the pairing passcode comprises at least one of:
a user-specific component;
an application-specific component;
a geography-specific component;
a time-specific component; or
a random component.

30. The apparatus of claim 27, further comprising memory to store the pairing passcode.

31. A computer program product comprising logic instructions stored on a non-transitory computer readable medium which, when executed on a processor, configure the processor to:
obtain a pairing passcode;
generate a vibration pattern in a vibration generator communicatively coupled to the apparatus from the pairing passcode;
receive an acknowledgement from a remote electronic device; and
in response to the acknowledgment, authorize a pairing relationship with the remote electronic device.

32. The computer program product of claim 31, further comprising logic instructions stored on a non-transitory computer readable medium which, when executed on a processor, configure the processor to:
initiate a request to a pairing passcode server; and
in response to the request, receive a pairing passcode from the pairing passcode server.

33. The computer program product of claim 28, wherein the pairing passcode comprises at least one of:
a user-specific component;
an application-specific component;
a geography-specific component;
a time-specific component; or
a random component.

34. The computer program product of claim 27, further comprising memory communicatively couple to the processor to store the pairing passcode.

35. An electronic device, comprising:
an accelerometer; and
logic, at least partially including hardware logic, configured to:
receive a vibration pattern from a remote electronic device; and
generate an acknowledgment vibration pattern when the vibration pattern received from the remote device matches the pairing passcode.

36. The electronic device of claim 35, wherein the logic is further configured to:
obtain a pairing passcode.

37. The electronic device of claim 35, wherein the logic is further configured to:
initiate a request to a pairing passcode server; and
in response to the request, receive a pairing passcode from the pairing passcode server.

38. The electronic device of claim 37, wherein the pairing passcode comprises at least one of:
a user-specific component;
an application-specific component;
a geography-specific component;
a time-specific component; or
a random component.

39. The electronic device of claim 35, further comprising memory to store the pairing passcode.

40. An apparatus, comprising:
logic, at least partially including hardware logic, configured to:
receive a vibration pattern from a remote electronic device; and
generate an acknowledgment vibration pattern when the vibration pattern received from the remote device matches the pairing passcode.

41. The apparatus of claim 40, wherein the logic is further configured to:
obtain a pairing passcode.

42. The apparatus of claim 40, wherein the logic is further configured to:
initiate a request to a pairing passcode server; and
in response to the request, receive a pairing passcode from the pairing passcode server.

43. The apparatus of claim 42, wherein the pairing passcode comprises at least one of:
a user-specific component;
an application-specific component;
a geography-specific component;
a time-specific component; or
a random component.

44. The apparatus of claim 40, further comprising memory to store the pairing passcode.
